(19) United States
(12) Patent Application Publication
(10) Pub. No.: US 2022/0291796 A1
(43) Pub. Date: Sep. 15, 2022

(54) TOUCH SENSING DEVICE AND TOUCH SENSING METHOD

(71) Applicant: Chicony Electronics Co., Ltd., New Taipei City (TW)

(72) Inventor: Chih-Yi Lu, New Taipei City (TW)

(21) Appl. No.: 17/466,673

(22) Filed: Sep. 3, 2021

(30) Foreign Application Priority Data
Mar. 10, 2021 (TW) 110108593

(51) Int. Cl. G06F 3/041; G06F 1/16

(52) U.S. Cl. CPC G06F 3/04144; G06F 1/169; G06F 3/0416

(57) ABSTRACT

A touch sensing device includes a substrate, a touch panel, a storage, and a processor. The touch panel includes a touch board and a circuit board between the substrate and the touch board. The circuit board includes a position sensor for detecting and obtaining a touch position on the touch board and a pressure sensor for detecting that the touch position is pressed to obtain a pressing pressure value. The storage stores first and second pressure thresholds which respectively correspond to first and second positions on the touch board. When the touch position is at the first position, in response to that the pressing pressure value is greater than the first pressure threshold, the processor outputs a trigger signal. When the touch position is at the second position, in response to that the pressing pressure value is greater than the second pressure threshold, the processor outputs the trigger signal.

### CROSS-REFERENCE TO RELATED APPLICATION

This non-provisional application claims priority under 35 U.S.C. § 119(a) to Patent Application No. 110108593 filed in Taiwan, R.O.C. on Mar. 10, 2021, the entire contents of which are hereby incorporated by reference.

### BACKGROUND

### Technical Field

The instant disclosure relates to a sensing device, in particular, to a touch sensing device and a touch sensing method.

### Related Art

Touchpads are common input devices widely applied in computers. The touchpad is provided for sensing the movement or pressing of a user's finger(s) to control the cursor to perform an action (e.g., to move, to click, or the like).

### SUMMARY

The pressing sensing of a touchpad known to the inventor is achieved by a physical switch, and the physical switch may be, for example, a metal dome switch or a rubber dome switch. When the touchpad is pressed by a user, the touchpad abuts against and presses the physical switch to deform the physical switch so as to allow the physical switch to conduct with the contact points to trigger the pressing signal(s). However, during the operation of the touchpad, the farer the pressing position from the physical switch is, the larger the value of the pressing force for deforming the physical switch to trigger the pressing signal(s) is. As a result, the user cannot operate the touchpad conveniently.

In view of this, in one embodiment, a touch sensing device is provided. The touch sensing device comprises a substrate, a touch panel, a storage, and a processor. The touch panel is disposed on the substrate. The touch panel comprises a touch board and a circuit board. The circuit board is between the substrate and the touch board. The circuit board comprises a pressure sensor and a position sensor. The position sensor is adapted to detect and obtain a touch position on the touch board. The pressure sensor is adapted to detect that the touch position is pressed to obtain a pressing pressure value. The storage stores a first pressure threshold and a second pressure threshold. The first pressure threshold and the second pressure threshold respectively correspond to a first position and a second position on the touch board, and the first pressure threshold is different from the second pressure threshold. A distance between the first position and the pressure sensor is different from a distance between the second position and the pressure sensor. The processor is electrically connected to the pressure sensor, the position sensor, and the storage. The processor is adapted to obtain the first pressure threshold, the second pressure threshold, the touch position, and the pressing pressure value. When the touch position is at the first position, in response to that the pressing pressure value is greater than the first pressure threshold, the processor outputs a trigger signal. When the touch position is at the second position, in response to that the pressing pressure value is greater than the second pressure threshold, the processor outputs the trigger signal.

In another embodiment, a touch sensing method is provided. The method comprises obtaining a touch position on a touch board and obtaining a pressing pressure value, where the pressing pressure value is generated upon the touch position is pressed; obtaining a first pressure threshold and a second pressure threshold, where the first pressure threshold and the second pressure threshold respectively correspond to a first position and a second position on the touch board, and the first pressure threshold is different from the second pressure threshold; when the touch position is at the first position, outputting a trigger signal in response to that the pressing pressure value is greater than the first pressure threshold; and when the touch position is at the second position, outputting the trigger signal in response to that the pressing pressure value is greater than the second pressure threshold.

As above, in the touch sensing device and the touch sensing method of one or some embodiments of the instant disclosure, different positions (the first position and the second position) on the touch board have different pressure thresholds (the first pressure threshold and the second pressure threshold). Moreover, when the touch position is at the first position, the trigger signal is outputted in response to that the pressing pressure value is greater than the first pressure threshold; when the touch position is at the second position, the trigger signal is outputted in response to that the pressing pressure value is greater than the second pressure threshold. Therefore, when the user touches different positions on the touch board, the pressing force applied by the user on the touch board for generating the trigger signal can be the same or close values. Hence, the user can operate the touch board conveniently and comfortably.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a touch sensing device according to a first embodiment of the instant disclosure;

FIG. 2 illustrates an exploded view of the touch sensing device of the first embodiment;

FIG. 3 illustrates a cross-sectional view of the touch sensing device of the first embodiment;

FIG. 4 illustrates a top view of the touch sensing device of the first embodiment;

FIG. 5 illustrates an exploded view of a touch sensing device according to a second embodiment of the instant disclosure;

FIG. 6 illustrates a top view of the touch sensing device of the second embodiment;

FIG. 7 illustrates an exploded view of a touch sensing device according to a third embodiment of the instant disclosure;

FIG. 8 illustrates a top view of the touch sensing device of the third embodiment; and

FIG. 9 illustrates a flowchart of a touch sensing method according to an exemplary embodiment of the instant disclosure.

### DETAILED DESCRIPTION

Embodiments are provided for facilitating the descriptions of the instant disclosure. However, the embodiments are provided as examples for illustrative purpose, but not a limitation to the instant disclosure. In all the drawings, the same reference numbers designate the same or similar elements.

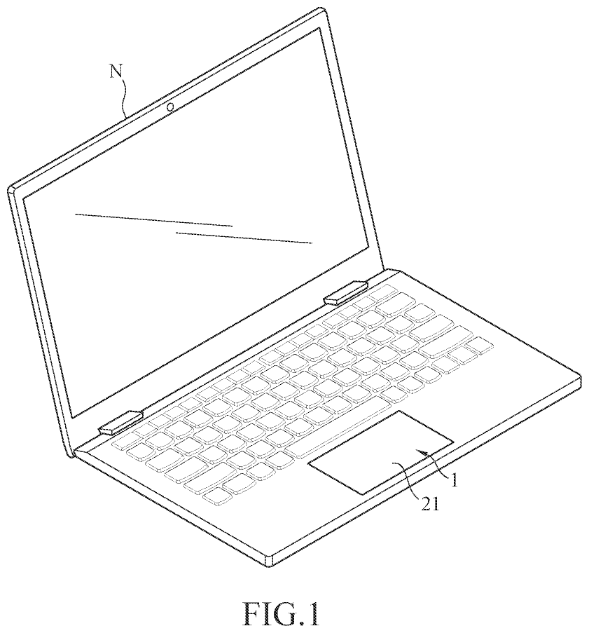

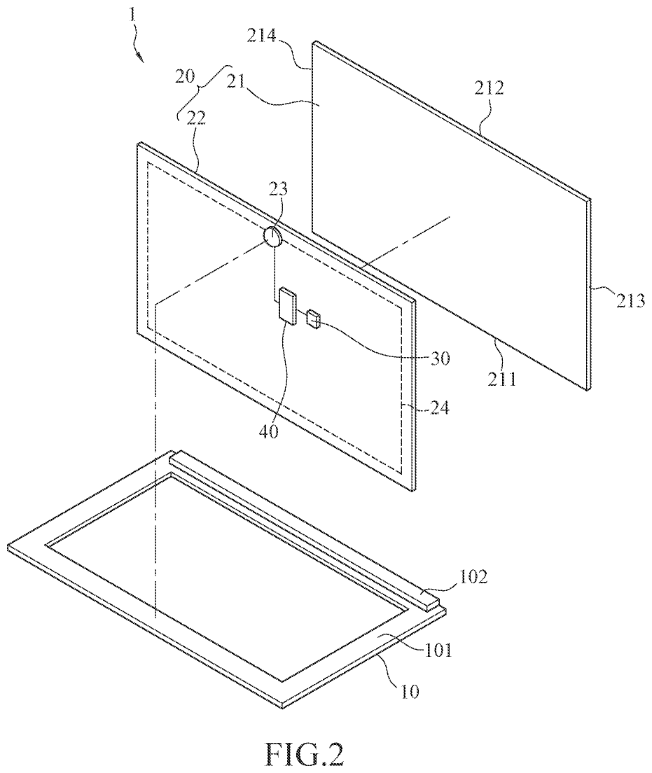

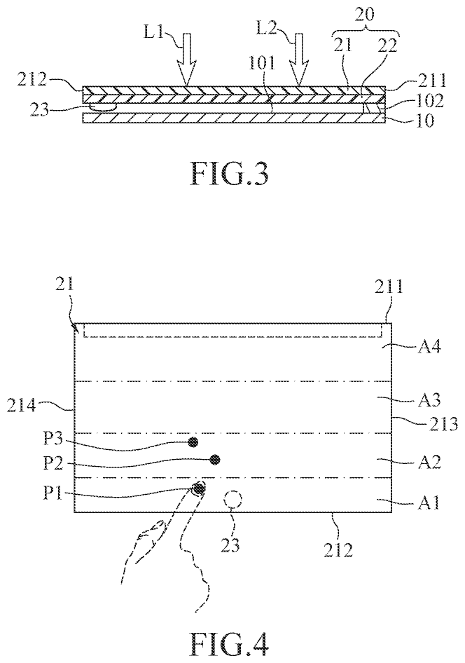

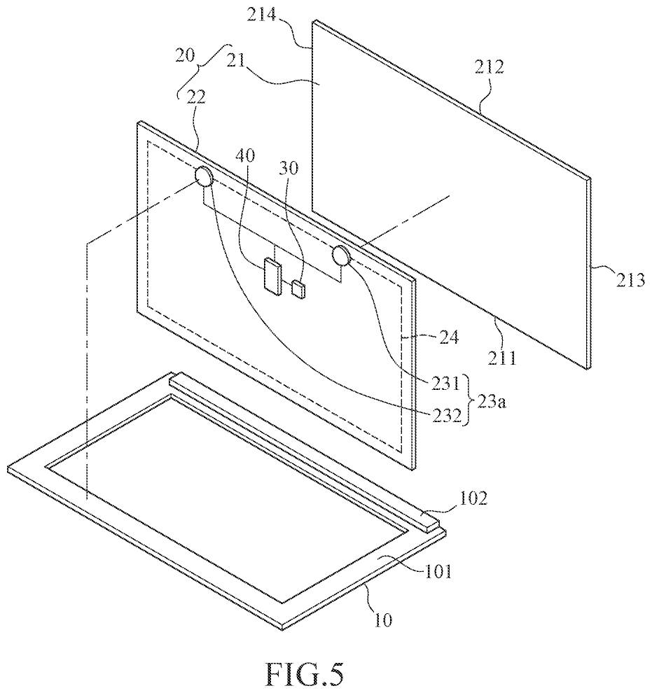

FIG. 1 illustrates a perspective view of a touch sensing device according to a first embodiment of the instant disclosure. FIG. 2 illustrates an exploded view of the touch sensing device of the first embodiment. FIG. 3 illustrates a cross-sectional view of the touch sensing device of the first embodiment. FIG. 4 illustrates a top view of the touch sensing device of the first embodiment. As shown in FIG. 1, the touchpad device 1 (e.g., a touchpad or a trackpad) may be applied in a computer product, and the user can operate the touchpad device 1 by sliding or pressing the touchpad device 1 with the user's finger(s) so as to control the movement of the cursor or to generate corresponding control signal(s). For example, as shown in FIG. 1, in this embodiment, the touchpad device 1 is applied in a notebook computer N, but embodiments are not limited thereto. In some embodiments, the touchpad device 1 may be applied in other portable computers (e.g., tablet computers). Alternatively, the touchpad device 1 may be an individual device and may be capable of externally connected to a computer product, but embodiments are not limited thereto.

As shown in FIGS. 2 and 3, in this embodiment, the touch sensing device 1 comprises a substrate 10, a touch panel 20, a storage 30, and a processor 40. The substrate 10 may be a rigid plate made of metal (e.g., iron, aluminum, alloy, etc.), or plastic material. In this embodiment, the substrate 10 is located at the lowest layer of the touchpad device 1 and has a top surface 101, and the touch panel 20 is disposed above the top surface 101.

As shown in FIGS. 2 and 3, the touch panel 20 comprises a touch board 21 and a circuit board 22. The touch board 21 and the circuit board 22 are stacked and fixed with each other, and the circuit board 22 is between the substrate 10 and the touch board 21. The touch board 21 is provided for being touched or pressed by the user. For example, the user's finger(s) may perform sliding or pressing on the touch board 21. In some embodiments, the touch board 21 may be a plate made of glass or polyester resin (mylar).

As shown in FIGS. 2 and 3, the circuit board 22 comprises a pressure sensor 23 and a position sensor 24. The position sensor 24 is adapted to detect and obtain a touch position on the touch board 21. In other words, in this embodiment, the position sensor 24 can detect the actual position on the surface of the touch board 21 touched by the user to obtain the touch position, and the touch position may be presented by a coordinate, but embodiments are not limited thereto. In some embodiments, the position sensor 24 may be a capacitive sensor, a piezoelectric sensor, a resistive sensor, an infrared sensor, or the like.

As shown in FIGS. 2 and 3, the pressure sensor 23 is adapted to detect that the touch position is pressed to obtain a pressing pressure value. In this embodiment, the pressure sensor 23 is adjacent to or in contact with the top surface 101 of the substrate 10. Therefore, when the user presses the surface of the touch board 21, the touch board 21 abuts against and presses the pressure sensor 23 through the circuit board 22, so that the pressure sensor 23 is pressed to detect the pressing pressure value on the touch position. For example, the pressing pressure value may be 30 gf (gram-force), 40 gf, 80 gf, 100 gf, 150 gf, or 200 gf, depending on the value of the pressing force of the user. In some embodiments, the pressure sensor 23 may be a capacitive pressure sensor, a piezoresistive pressure sensor, a piezoelectric pressure sensor, or the like, and the pressing pressure value may be presented in other pressure units.

Further, as shown in FIGS. 2 and 3, the touch board 21 comprises a pivot side 211, and the pivot side 211 is pivotally connected to one side of the substrate 10. In this embodiment, a bar-shaped block 102 is fixedly disposed on one side of the substrate 10 adjacent to the pivot side 211. The pivot side 211 of the touch board 21 may be assembled on and fixed on the bar-shaped block 102 by adhering, engaging, locking, or other ways, so that the touch board 21 is swingable relative to the substrate 10 by taking the pivot side 211 as the fulcrum. Moreover, in this embodiment, the touch board 21 further has an opposite side 212 opposite to the pivot side 211, and the pressure sensor 23 is disposed between the opposite side 212 and the substrate 10. However, it should be understood that, the foregoing embodiments are provided for illustrative purposes; in some embodiments, the pivot side 211 of the touch board 21 may be pivotally connected to one side of the substrate 10 through other ways, and the pressure sensor 23 may be disposed between the pivot side 211 and the opposite side 212.

As shown in FIGS. 2 and 3, the storage 30 stores several different pressure thresholds to correspond to different positions on the surface of the touch board 21. For example, please refer to FIG. 4, the storage 30 may at least store a first pressure threshold and a second pressure threshold, and the first pressure threshold and the second pressure threshold respectively correspond to a first position P1 and a second position P2 on the touch board 21. The first position P1 and the second position P2 may be presented by coordinates, and the first pressure threshold is different from the second pressure threshold. A distance between the first position P1 and the pressure sensor 23 is different from a distance between the second position P2 and the pressure sensor 23. For example, the first pressure threshold may be 190 gf, the second pressure threshold may be 152 gf, and the distance between the first position P1 and the pressure sensor 23 is less than the distance between the second position P2 and the pressure sensor 23, but embodiments are not limited thereto. The storage 30 may store different pressure thresholds to correspond to every coordinate positions on the surface of the touch board 21.

In some embodiments, the storage 30 may be fixed or portable, and may be an RAM (random access memory), an ROM (read-only memory), a flash memory, a hard drive, other similar devices, or a combination thereof.

As shown in FIGS. 2 and 3, the processor 40 is electrically connected to the pressure sensor 23, the position sensor 24, and the storage 30 so as to obtain the different pressure thresholds (such as the first pressure threshold and the second pressure threshold), the touch position of the user, and the pressing pressure values detected by the pressure sensor 23. In some embodiments, the pressure sensor 23, the position sensor 24, the storage 30, and the processor 40 may be disposed on the same circuit board 22 (as shown in FIG. 2); in some other embodiments, the storage 30 and the processor 40 may be respectively disposed on other portions out of the circuit board 22.

In some embodiments, the processor 40 may be a central processing unit (CPU), or may be other programmable microprocessors, digital signal processors (DSP), programmable controllers, application specific integrated circuits (ASIC), programmable logic devices (PLD), or other similar devices. The processor 40 is provided for controlling and coordinating the operations between units and modules of the touch sensing device 1 and for data calculation as well as logic determination of the touch sensing device 1.

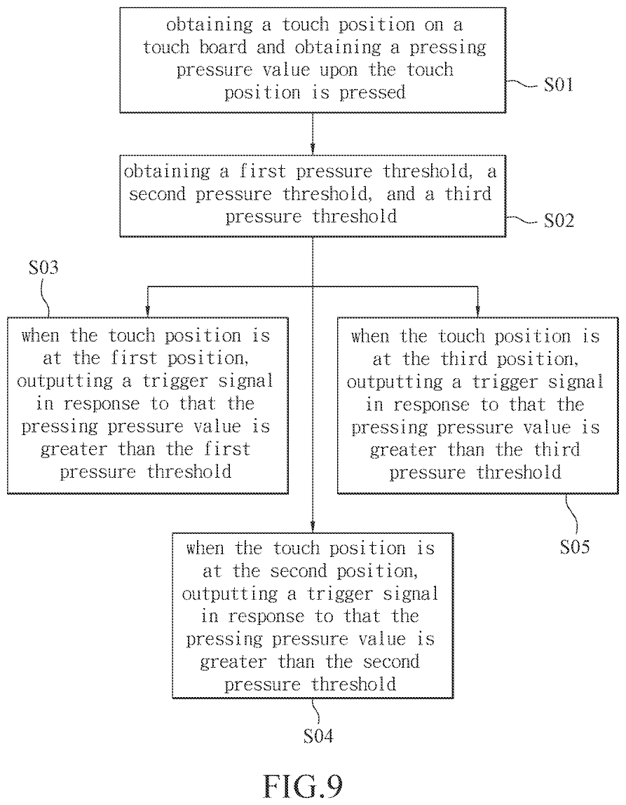

As shown in FIGS. 2 to 4, when the touch positions of the user are at different positions of the touch board 21, the processor 40 compares the pressing pressure value with different pressure thresholds to determine to output or not to output the trigger signal. The trigger signal may control the cursor to perform the selection action. As shown in FIG. 9, which illustrates a flowchart of a touch sensing method according to an exemplary embodiment of the instant disclosure. In this embodiment, the processor 40 of the touch sensing device 1 shown in FIGS. 2 to 4 can execute following step S01 to step S05 to perform the touch sensing operation, the hardware structures described in the following paragraphs may be referred back to the embodiments shown in FIGS. 1 to 4, but it should be noted that, the structures provided in the embodiments of FIGS. 1 to 4 are not limitations for the instant disclosure.

As shown in FIG. 9, the step S01: obtaining a touch position on a touch board and obtaining a pressing pressure value, where the pressing pressure value is generated upon the touch position is pressed. Please refer to FIGS. 2 to 4, when the user's finger(s) touches the surface of the touch board 21, the position sensor 24 detects the coordinate of the user's finger(s) on the touch board 21 so as to obtain the touch position of the finger(s). When the user's finger(s) performs click or press operations at the touch position, the operation make the pressure sensor 24 be pressed, so that the pressure sensor 24 can detect and obtain the pressing pressure value at the touch position. The processor 40 is electrically connected to the pressure sensor 24 and the position sensor 23 to obtain the touch position and the pressing pressure value.

As shown in FIG. 9, the step S02: obtaining a first pressure threshold, a second pressure threshold, and a third pressure threshold. Specifically, in this embodiment, as shown in FIGS. 1 to 4, the storage 30 may store two or more pressure thresholds in advance to correspond to different positions on the touch board 21. For sake of explanation, in this embodiment, as an example, the storage 30 stores three different pressure thresholds (the first pressure threshold, the second pressure threshold, and the third pressure threshold), and the processor 40 is electrically connected to the storage 30 to obtain the first pressure threshold, the second pressure threshold, and the third pressure threshold, but embodiments are not limited thereto. The number of the pressure thresholds stored in the storage 30 is depended on the number of the coordinate positions predetermined on the touch board 21. For example, when the number of the coordinate positions predetermined on the touch board 21 is 100, the storage 30 stores 100 different pressure thresholds to correspond to the 100 coordinate positions.

Furthermore, as shown in FIGS. 2 to 4, the first pressure threshold, the second pressure threshold, and the third pressure threshold respectively correspond to a first position P1, a second position P2, and a third position P3 on the touch board 21. The first position P1, the second position P2, and the third position P3 may be presented by coordinates, and a distance between the first position P1 and the pressure sensor 23, a distance between the second position P2 and the pressure sensor 23, and a distance between the third position P3 and the pressure sensor 23 are all different from each other.

In some embodiments, the step S01 may be executed after the step S02, or the step S01 and the step S02 may be executed at the same time.

Further, as shown in FIG. 9, the step S03: when the touch position is at the first position, outputting a trigger signal in response to that the pressing pressure value is greater than the first pressure threshold; the step S04: when the touch position is at the second position, outputting a trigger signal in response to that the pressing pressure value is greater than the second pressure threshold; and the step S05: when the touch position is at the third position, outputting a trigger signal in response to that the pressing pressure value is greater than the third pressure threshold. Specifically, as shown in FIGS. 2 to 4, in this embodiment, after the processor 40 obtains the touch position of the user, the processor 40 may judge the touch position corresponds to the first position P1, the second position P2, or the third position P3 on the touch board 21 in advance. Moreover, when the touch positions of the user are at different positions of the touch board 21, the processor 40 compares the pressing pressure value with different pressure thresholds to determine to output or not to output the trigger signal.

Specifically, as shown in FIG. 3, in the condition that the pressure threshold is not set, supposed that the pressure sensor 23 is triggered upon detecting a pressure value greater than 190 gf, when the pressed position of the user on the touch board 21 is farer from the pressure sensor 23 or nearer to the pivot side 211 of the touch board 21, the user has to apply a larger pressing force to allow the pressor sensor 23 to detect a pressure value greater than 190 gf. For example, when the pressed position of the user is at the position indicated by the arrow L1, the value of the pressing force allowing the pressure sensor 23 to detect a pressure value greater than 190 gf is 238 gf; when the pressed positon of the user is at the position indicated by the arrow L2, the value of the pressing force allowing the pressure sensor 23 to detect a pressure value greater than 190 gf is 380 gf. As a result, for triggering the pressure sensor 23 without setting the pressure threshold, when the user presses different positions on the touch board 21, the user has to press the touch board 21 with different values of the pressing forces.

Furthermore, in this embodiment, when the position on the touch board 21 is nearer to the pivot side 211, the pressure threshold corresponding to the position is set lesser, or alternatively when the position on the touch board 21 is nearer to the pressure sensor 23, the pressure threshold corresponding to the position is set greater. As shown in FIG. 4, for example, in this embodiment, the distance between the third position P3 and the pressure sensor 23 is greater than the distance between the second position P2 and the pressure sensor 23, the distance between the second position P2 and the pressure sensor 23 is greater than the distance between the first position P1 and the pressure sensor 23, the distance between the third position P3 and the pivot side 211 is less than the distance between the second position P2 and the pivot side 211, and the distance between the second position P2 and the pivot side 211 is less than the distance between the first position P1 and the pivot side 211. Therefore, the first pressure threshold corresponding to the first position P1 is greater than the second pressure threshold corresponding to the second position P2, and the second pressure threshold corresponding to the second position P2 is greater than the third pressure threshold corresponding to the third position P3. For example, the first pressure threshold may be 190 gf, the second pressure threshold may be 152 gf, and the third pressure threshold may be 95 gf.

Accordingly, as shown in FIGS. 3 and 4, when the touch position of the user is at the first position and the user presses the touch board 21 by a pressing force (as shown in FIG. 4), in response to that the pressing pressure value detected by the pressure sensor 23 is greater than the first pressure threshold (190 gf), the processor 40 outputs the trigger signal to control the cursor to perform the selection action; conversely, when the pressing pressure value is less than or equal to the first pressure threshold, the processor 40 does not output the trigger signal. When the touch position of the user is at the second position, in response to that the pressing pressure value detected by the pressure sensor 23 is greater than the second pressure threshold (152 gf), the processor 40 outputs the trigger signal. Therefore, the value of the pressing force applied by the user upon the user touches the second position on the touch board 21 for generating the trigger signal can be the same as or close to the value of the pressing force applied by the user upon the user touches the first position on the touch board 21 for generating the trigger signal. When the touch position of the user is at the third position, in response to that the pressing pressure value detected by the pressure sensor 23 is greater than the third pressure threshold (95 gf), the processor 40 outputs the trigger signal. Therefore, the value of the pressing force applied by the user upon the user touches the third position on the touch board 21 for generating the trigger signal can be the same as or close to the values of the pressing forces applied by the user upon the user touches the first position or the second position on the touch board 21 for generating the trigger signal. Hence, when the user touches different positions on the touch board 21, the pressing force applied by the user on the touch board 21 for generating the trigger signal can be the same or close values. Accordingly, the user can operate the touch board 21 conveniently and comfortably.

Furthermore, as shown in FIG. 4, the touch board 21 may be divided into several regions, and the pressure thresholds corresponding to several positions at the same region may be set as the same. In this embodiment, the surface of the touch board 21 is divided into four regions, namely, a first region A1, a second region A2, a third region A3, and a fourth region A4, respectively. In this embodiment, the shape of each of the regions is rectangle, but embodiments are not limited thereto. The number of the regions divided from the touch board 21 may be two or more, and the regions may be of other shapes. In this embodiment, the first region A1, the second region A2, the third region A3, and the fourth region A4 are sequentially arranged from the opposite side 212 to the pivot side 211. In other words, in this embodiment, the second region A2 is nearer to the pivot side 211 as compared with the first region A1 (namely, the distance between the second region A2 and the pivot side 211 is shorter than the distance between the first region A1 and the pivot side 211), the third region A3 is nearer to the pivot side 211 as compared with the second region A2 (namely, the distance between the third region A3 and the pivot side 211 is shorter than the distance between the second region A2 and the pivot side 211), and the fourth region A4 is nearer to the pivot side 211 as compared with the third region A3 (namely, the distance between the fourth region A4 and the pivot side 211 is shorter than the distance between the third region A3 and the pivot side 211). Moreover, in this embodiment, the first position P1 is in the first region A1, the second position P2 and the third position P3 are in the second region A2. The second pressure threshold and the third pressure threshold respectively corresponding to the second position P2 and the third position P3 which are both in the same region (in this embodiment, namely, the second region A2) may be set as the same, and both the second pressure threshold and the third pressure threshold are less than the first pressure threshold corresponding to the first position P1. Similarly, the pressure thresholds corresponding to positions of the same region (which may be the first region A1, the third region A3, or the fourth region A4) may be set as the same; repeated descriptions are omitted herein.

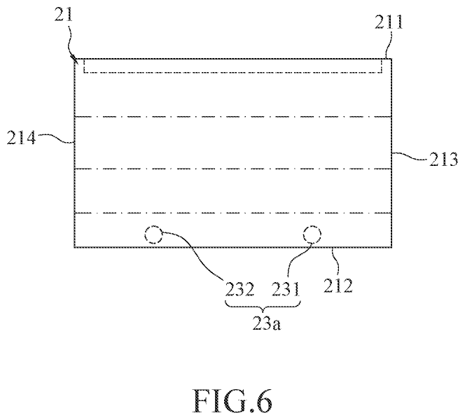

FIG. 5 illustrates an exploded view of a touch sensing device according to a second embodiment of the instant disclosure. FIG. 6 illustrates a top view of the touch sensing device of the second embodiment. As shown in FIGS. 5 and 6, in this embodiment, the touch board 21 comprises a first side 213 and a second side 214 opposite to the first side 213, and the first side 213 and the second side 214 are connected between the pivot side 211 and the opposite side 212. That is, in this embodiment, the pivot side 211, the opposite side 212, the first side 213, and the second side 214 are formed as an outer periphery of the touch board 21. The difference between this embodiment and the embodiment shown in FIG. 4 is at least that, in this embodiment, the pressure sensor 23a comprises a first pressure sensing unit 231 and a second pressure sensing unit 232. The first pressure sensing unit 231 and the second pressure sensing unit 232 are spacedly disposed and are respectively adjacent to the first side 213 and the second side 214. Therefore, when the touch board 21 is pressed by the user, the pressing force may be proper distributed to the first pressure sensing unit 231 and the second pressure sensing unit 232 to prevent the touch board 21 from having warpage or shaking, thereby improving the stability of the touch board 21 during operation.

Furthermore, in this embodiment, when the user presses the touch board 21, the first pressure sensing unit 231 is adapted to detect that the touch position of the touch board 21 is pressed to obtain a first pressing pressure value, and the second pressure sensing unit 232 is adapted to detect that the touch position of the touch board 21 is pressed to obtain a second pressing pressure value, and the pressing pressure value of the foregoing embodiments is a summation of the first pressing pressure value and the second pressing pressure value.

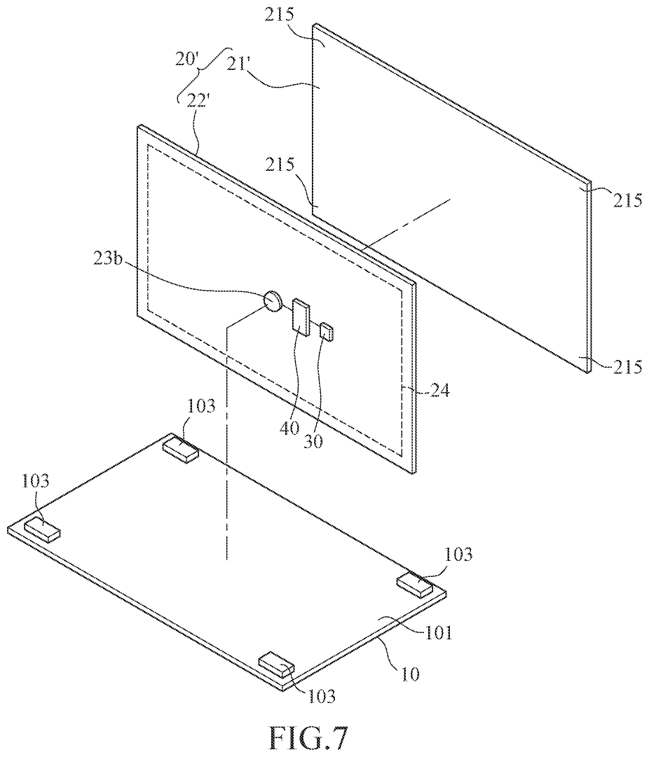

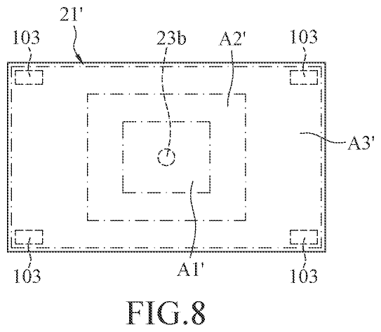

As shown in FIGS. 7 and 8, an exploded view and a top view of a touch sensing device according to a third embodiment of the instant disclosure are respectively illustrated. The difference between the third embodiment and the first embodiment is that, in this embodiment, the touch board 21′ of the touch panel 20′ comprises a plurality of pivot portions 215. The pivot portions 215 are portions of the surface of the touch board 21′, and the pivot portions 215 are respectively at four corners of the touch board 21′. In this embodiment, blocks 103 are respectively disposed on the four corners of the top surface 101 of the substrate 10, and the pivot portions 215 may be assembled on and fixed on the blocks 103 by adhering, engaging, locking or other ways. The pressure sensor 23b is between the pivot portions 215. In this embodiment, the pressure sensor 23b corresponds to a center portion of the circuit board 22′ and is between the pivot portions 215, and the first region A1′, the second region A2′, and the third region A3′ of the touch board 21′ are in rectangular ring shapes with different sizes, and the first region A1′, the second region A2′, and the third region A3′ are concentrically arranged by taking the pressure sensor 23b as the center.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A touch sensing device comprising:
a substrate;
a touch panel disposed on the substrate, wherein the touch panel comprises a touch board and a circuit board, the circuit board is between the substrate and the touch board, the circuit board comprises a pressure sensor and a position sensor, the position sensor is adapted to detect and obtain a touch position on the touch board, and the pressure sensor is adapted to detect that the touch position is pressed to obtain a pressing pressure value;
a storage storing a first pressure threshold and a second pressure threshold, wherein the first pressure threshold and the second pressure threshold respectively correspond to a first position and a second position on the touch board, the first pressure threshold is different from the second pressure threshold, and a distance between the first position and the pressure sensor is different from a distance between the second position and the pressure sensor; and
a processor electrically connected to the pressure sensor, the position sensor, and the storage, wherein the processor is adapted to obtain the first pressure threshold, the second pressure threshold, the touch position, and the pressing pressure value;
wherein when the touch position is at the first position, in response to that the pressing pressure value is greater than the first pressure threshold, the processor outputs a trigger signal;
wherein when the touch position is at the second position, in response to that the pressing pressure value is greater than the second pressure threshold, the processor outputs the trigger signal.

2. The touch sensing device according to claim 1, wherein the distance between the first position and the pressure sensor is less than the distance between the second position and the pressure sensor, and the second pressure threshold is less than the first pressure threshold.

3. The touch sensing device according to claim 2, wherein the touch board comprises a plurality of pivot portions, the pivot portions are at four corners of the touch board, and the pressure sensor is between the pivot portions.

4. The touch sensing device according to claim 1, wherein the touch board comprises a pivot side, the pivot side is pivotally connected to one side of the substrate, the second position is nearer to the pivot side as compared with the first position, and the second pressure threshold is less than the first pressure threshold.

5. The touch sensing device according to claim 4, wherein the touch board comprises an opposite side opposite to the pivot side, and the pressure sensor is disposed between the opposite side and the substrate.

6. The touch sensing device according to claim 5, wherein the touch board comprises a first side and a second side opposite to the first side, the first side and the second side are connected between the pivot side and the opposite side, the pressure sensor comprises a first pressure sensing unit and a second pressure sensing unit, and the first pressure sensing unit and the second pressure sensing unit are spaced disposed and are respectively adjacent to the first side and the second side.

7. The touch sensing device according to claim 1, wherein the pressure sensor comprises a first pressure sensing unit and a second pressure sensing unit, the first pressure sensing unit is adapted to detect that the touch position is pressed to obtain a first pressing pressure value, the second pressure sensing unit is adapted to detect that the touch position is pressed to obtain a second pressing pressure value, and the pressing pressure value is a summation of the first pressing pressure value and the second pressing pressure value.

8. The touch sensing device according to claim 1, wherein the storage stores a third pressure threshold, the third pressure threshold corresponds to a third position on the touch board, the second is between the first position and the third position, and wherein when the touch position is at the third position, in response to that the pressing pressure value is greater than the third pressure threshold, the processor outputs the trigger signal.

9. The touch sensing device according to claim 8, wherein the touch board comprises a first region and a second region, the second region is farer from the pressure sensor as compared with the first region, the first position is in the first region, the second position and the third position are in the second region, and the second pressure threshold is equal to the third pressure threshold.

10. The touch sensing device according to claim 8, wherein the third position is farer from the pressure sensor as compared with the second position, and the third pressure threshold is less than the second pressure threshold.

11. A touch sensing method comprising:
(a) obtaining a touch position on a touch board and obtaining a pressing pressure value, wherein the pressing pressure value is generated upon the touch position is pressed;
(b) obtaining a first pressure threshold and a second pressure threshold, wherein the first pressure threshold and the second pressure threshold respectively correspond to a first position and a second position on the touch board, and the first pressure threshold is different from the second pressure threshold;
(c) when the touch position is at the first position, outputting a trigger signal in response to that the pressing pressure value is greater than the first pressure threshold; and
(d) when the touch position is at the second position, outputting the trigger signal in response to that the pressuring pressure value is greater than the second pressure threshold.

12. The touch sensing method according to claim 11, wherein the touch board in the step (b) comprises a pivot side, the second position is nearer to the pivot side as compared with the first position, and the second pressure threshold is less than the first pressure threshold.

13. The touch sensing method according to claim 11, wherein the pressing pressure value in the step (a) is a summation of a first pressing pressure value and a second pressing pressure value, the first pressing pressure value is obtained by using a first pressure sensing unit to detect that the touch position is pressed, and the second pressing pressure is obtained by using a second pressure sensing unit to detect that the touch position is pressed.

14. The touch sensing method according to claim 12, wherein the step (b) further comprises: obtaining a third pressure threshold, the third pressure threshold corresponds to a third position on the touch board, and the second position is between the first position and the third position, and wherein after the step (b), the method further comprises: when the touch position is at the third position, outputting the trigger signal in response to that the pressuring pressure value is greater than the third pressure threshold.

15. The touch sensing method according to claim 14, wherein the touch board in the step (b) comprises a first region and a second region, the second region is nearer to the pivot side as compared with the first region, the first position is in the first region, the second position and the third position are in the second region, and the second pressure threshold is equal to the third pressure threshold.

16. The touch sensing method according to claim 14, wherein the third position in the step (b) is nearer to the pivot side as compared with the second position, and the third pressure threshold is less than the second pressure threshold.
